(19) United States
(12) Patent Application Publication
(10) Pub. No.: US 2015/0248078 A1
(43) Pub. Date: Sep. 3, 2015

(54) IMAGE FORMING APPARATUS

(71) Applicant: CANON KABUSHIKI KAISHA, Tokyo (JP)

(72) Inventors: Naoki Mugita, Toride-shi (JP); Katsuya Nose, Matsudo-shi (JP); Toshihisa Yago, Toride-shi (JP); Fumiyoshi Saito, Toride-shi (JP)

(21) Appl. No.: 14/626,013

(22) Filed: Feb. 19, 2015

(30) Foreign Application Priority Data
Feb. 28, 2014 (JP) 2014-038531

(51) Int. Cl. G03G 15/08

(52) U.S. Cl. CPC G03G 15/0898

(57) ABSTRACT

A sheet member is adhered to a circumference of the communication port such that a part thereof in a removing direction to be removed is wider in area in a width direction orthogonal to the removing direction than another part. Therefore, a load required in removing the part in the removing direction increases. The parts in the removing direction of a plurality of sheet members are removed at timing different from each other. This arrangement makes it possible to reduce the load because the timings causing the high load in removing the sheet members are shifted.

### BACKGROUND OF THE INVENTION

1. Field of the Invention

The present invention relates to an image forming apparatus including a pluralities of developing apparatuses each of which stores developer into a first chamber in an initial state.

2. Description of the Related Art

An image forming apparatus of electro-photographic and electrostatic recording systems such as a copier, a printer, a facsimile, and a multi-function printer having functions of those apparatuses is configured to form an electrostatic latent image on a surface of an image carrier such as a photosensitive drum and to form a toner image by developing the electrostatic latent image by toner. Hitherto, as a developing apparatus developing the electrostatic latent image by toner, there is known a developing apparatus using two-component developer containing toner and carrier. Such developing apparatus includes first and second chambers and electrifies the toner by agitating the toner and carrier by circulating and conveying the developer through the first and second chambers. Then, the developer is carried on a developing sleeve disposed in the second chamber to convey the developer to a part facing to the photosensitive drum and to develop the electrostatic latent image on the photosensitive drum by the toner.

As the developing apparatus as described above, Japanese Patent Laid-open No. 2004-252174 proposes a configuration of charging the developer into the first chamber of the developing apparatus in an initial state by sealing a communicating portion between the first and second chambers by a sealing member.

In the configuration in which the initial developer is sealed by the sealing member as described above, it may be able to remove the sealing member by using a driving source of the developing apparatus. In such a case, it may be able to adhere the sealing members around a plurality of communication ports forming a circulation path and peeling off the sealing member from the circumference of each communication port by a removing device driven by the driving source. However, if the developing apparatus is constructed as described above, a driving load increases if operations for removing the sealing members from the plurality of communication ports are started simultaneously because loads required in peeling off the sealing members also act in the same time.

For instance, if timings of peeling off parts whose adhesion area is larger than those of other parts among parts adhering the sealing members with the circumferences of the communication ports overlap, the driving load increases further. Still further, in a case where there is a developing apparatus per each color and the respective developing apparatuses are driven by one driving source like a full-color image forming apparatus, the driving load increases more if the timings for removing the sealing members of the respective developing apparatuses overlap.

### SUMMARY OF THE INVENTION

According to a first aspect of the present invention, an image forming apparatus includes an image forming apparatus comprising a plurality of developing apparatuses, each of the developing apparatuses including a first chamber storing developer in an initial state and having at least one communication port communicating an inside and an outside of the first chamber, a second chamber forming a circulation path of the developer with the first chamber during operation, at least one sealing member sealing the communication port by being adhered to a circumference of the communication port in the initial state, the sealing member including a wide adhesion part which is adhered to be wider in area in a width direction orthogonal to a removing direction to be removed than another part in the removing direction, and a removing device configured to remove the sealing member from the communication port, a driving source driving each removing device of the plurality of developing apparatuses, a plurality of switching devices switching connection/disconnection of transmission of a drive of the driving source and each removing device, and a control portion controlling the plurality of switching devices such that the wide adhesion part of each sealing member is removed at timings different from each other per each developing apparatus.

According to a second aspect of the present invention, An image forming apparatus includes a plurality of developing apparatuses, each of the developing apparatuses including, a first chamber storing developer in an initial state and having at least one communication port communicating an inside and an outside of the first chamber, a second chamber forming a circulation path of the developer with the first chamber during operation, at least one sheet member sealing the communication port by being adhered to a circumference of the communication port in the initial state, the sealing member including a wide adhesion part which is adhered to be wider in area in a width direction orthogonal to a removing direction to be removed than another part in the removing direction, and a winding device configured to remove the sheet member from the communication port by winding up the sheet member, and a driving source driving each winding device of the plurality of developing apparatuses, wherein the wide adhesion parts of the sheet members of the plurality of developing apparatus are removed at different timings from each other per each developing apparatuses.

According to a third aspect of the present invention, an image forming apparatus includes a plurality of developing apparatuses, each of the developing apparatuses including, a first chamber storing developer in an initial state and having at least one communication port communicating an inside and an outside of the chamber, a second chamber forming a circulation path of the developer with the first chamber during operation, at least one sealing member sealing the communication port in the initial state, and a removing device configured to remove the sealing member from the communication port, and a driving source driving each removing device of the plurality of developing apparatuses, wherein the removing devices remove the sealing members such that a maximum value of a load in removing of each sealing member of the plurality of developing apparatuses is shifted from each other.

Further features of the present invention will become apparent from the following description of exemplary embodiments with reference to the attached drawings. The accompanying drawings, which are incorporated in and constitute a part of the specification, illustrate exemplary embodiments, features, and aspects of the invention and, together with the description, serve to explain the principles of the invention.

### BRIEF DESCRIPTION OF THE DRAWINGS

FIG. 1 is a schematic diagram showing a configuration of an image forming apparatus of a first embodiment of the invention.

FIG. 2 is a schematic longitudinal section view of a configuration of a developing apparatus of the first embodiment.

FIG. 3 is a diagram in which the schematic longitudinal section view of the configuration of the developing apparatus in an initial state of the first embodiment is combined with a control block diagram.

FIG. 4A is a schematic transverse section view showing a configuration of the developing apparatus in the initial state of the first embodiment.

FIG. 4B is a longitudinal section view of the developing apparatus taken along a line X-X in FIG. 4A.

FIG. 5 is a schematic diagram showing a portion of a sheet member adhered to a partition wall of the first embodiment.

FIG. 6 is a side view showing a configuration of a drive transmitting portion of the developing apparatus of the first embodiment.

FIG. 7 is a graph showing torque applied to a driving motor by peeling one sheet member in initially starting one developing apparatus of the first embodiment.

FIG. 8 is a flowchart showing processes in initially starting the developing apparatus of the first embodiment.

FIG. 9A is a schematic structural transverse section view showing a state while removing the sheet member in the process in initially starting the developing apparatus of the first embodiment.

FIG. 9B is a longitudinal section view of the developing apparatus taken along a line X-X in FIG. 9A.

FIG. 9C is a schematic structural transverse section view showing a state after removing the sheet member in the process in initially starting the developing apparatus of the first embodiment.

FIG. 9D is a longitudinal section view of the developing apparatus taken along a line X-X in FIG. 9C.

FIG. 10 is a graph showing torque applied to the driving motor by peeling two sheet members in initially starting the developing apparatus of the first embodiment.

FIG. 11 is a timing chart showing drive starting timing of each developing apparatus of comparative examples.

FIG. 12 is a timing chart showing drive starting timing of each developing apparatus of the first embodiment.

FIG. 13 is a timing chart showing drive starting timing of respective developing apparatuses of a second embodiment.

FIG. 14 is a table showing sheet member peeling starting and ending timings of the respective developing apparatuses of the second embodiment.

### DESCRIPTION OF THE EMBODIMENTS

### First Embodiment

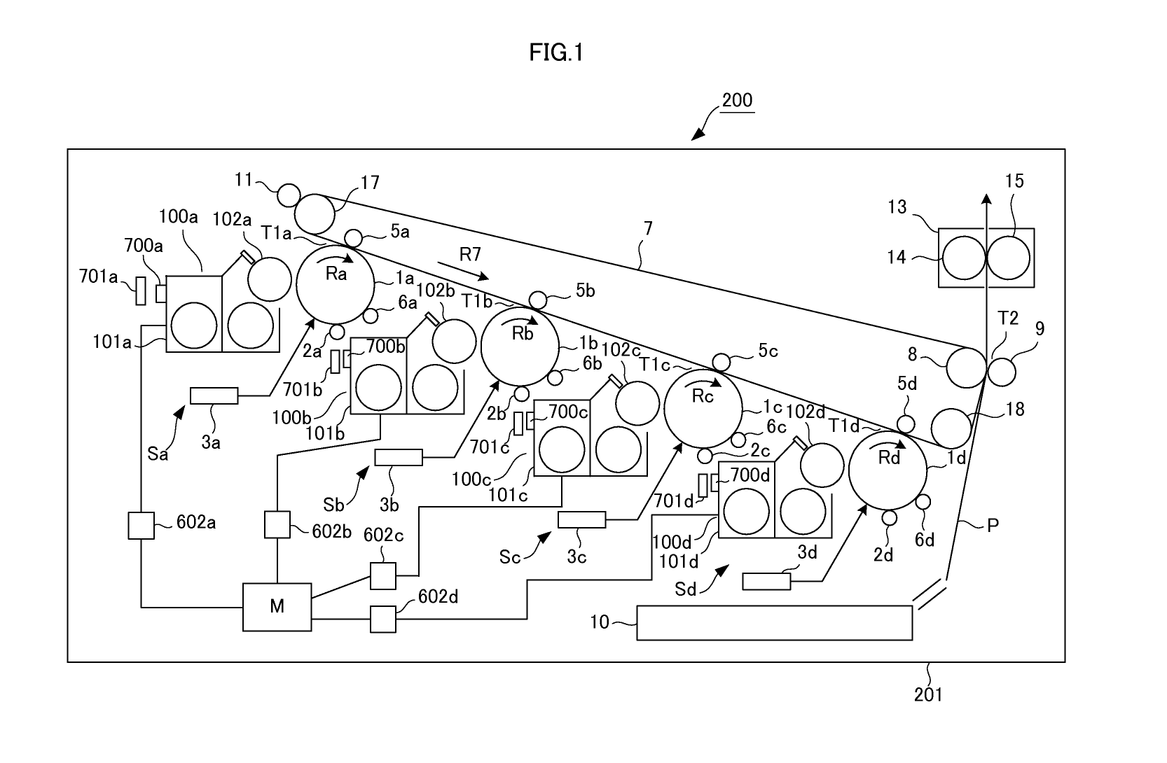

A first embodiment of the present invention will be described with reference to FIGS. 1 through 12. Firstly, a schematic structure of an image forming apparatus of the present embodiment will be described with reference to FIG. 1.

### [Image Forming Apparatus]

An image forming apparatus 200 is one exemplary full-color image forming apparatus and includes four image forming portions (image forming stations) Sa, Sb, Sc, and Sd disposed along a rotation direction (in a direction of an arrow R7) of an intermediate transfer belt 7, i.e., an intermediate transfer body. The respective image forming portions Sa, Sb, Sc, and Sd form toner images of colors of yellow, magenta, cyan, and black, respectively, and include photosensitive drums 1a, 1b, 1c and 1d, i.e., image carriers or drum-like photosensitive bodies.

The photosensitive drums 1a, 1b, 1c and 1d (subscripts will be omitted below because the photosensitive drums of the respective colors have the same configuration) are rotationally driven in direction Ra, Rb, Rc, and Rd (clockwise in FIG. 1), respectively. Disposed around each photosensitive drum 1 are, in order along the rotational direction thereof, are primary chargers, i.e., chargers, 2a, 2b, 2c, and 2d, exposure apparatuses, i.e., latent image forming portions 3a, 3b, 3c, and 3d, developing apparatuses, i.e., developing portions, 100a, 100b, 100c, and 100d, primary transfer rollers, i.e., primary transfer portions, 5a, 5b, 5c, and 5d, and secondary chargers, i.e., charge auxiliary portions, 6a, 6b, 6c, and 6d.

An endless intermediate transfer belt 7, i.e., an intermediate transfer body, is wrapped around the primary transfer rollers 5a through 5d, the secondary transfer counter roller 8, and tension rollers 17 and 18. The intermediate transfer belt 7 is pressed by the primary transfer rollers 5a through 5d from a back thereof and a front surface thereof is in contact with the photosensitive drums 1. Thereby, primary transfer nips, i.e., primary transfer portions, T1a, T1b, T1c, and T1d, are formed respectively between the photosensitive drum 1 and the intermediate transfer belt 7. The intermediate transfer belt 7 rotates in a direction of an arrow R7 along with rotation of a secondary transfer counter roller 8 which functions also as a driving roller. Rotational speed of the intermediate transfer belt 7 is substantially equalized with rotational speed (process speed) of the respective photosensitive drums 1 described above.

A secondary transfer roller 9, i.e., a secondary transfer portion, is disposed at a position corresponding to the secondary transfer counter roller 8 on a surface of the intermediate transfer belt 7. The secondary transfer roller 9 nips the intermediate transfer belt 7 with the secondary transfer counter roller 8 and a secondary transfer nip portion T2, i.e., the secondary transfer portion, is formed between the secondary transfer roller 9 and the intermediate transfer belt 7. Still further, a belt cleaner 11, i.e., an intermediate transfer body cleaner, is in contact with the surface of the intermediate transfer belt 7 at a position corresponding to the tension roller 17.

A recording medium P such as a sheet of paper, an OHP sheet, and others on which an image is to be formed is stored while being stacked in a cassette 10. The recording medium P is supplied to the secondary transfer nip portion T2 described above by a sheet supplying and conveying apparatus including a feed roller, a conveying roller, a registration roller, and others (none are shown). Disposed downstream the secondary transfer nip portion T2 along a conveying direction of the recording medium P is a fixing apparatus 13 including a fixing roller 14 and a pressure roller 15 pressed to the fixing roller 14, and disposed further downstream of the fixing apparatus 13 is a discharge tray (not shown).

In the image forming apparatus 200 constructed as described above, a full-color toner image is formed on the recording medium P. When a document is read by a scanner not shown, image information of components of yellow, magenta, cyan, and black are obtained. It is noted that there is also a case when image signals are sent from an external terminal such as a personal computer. In succession, the photosensitive drum 1 is rotationally driven in the direction of the arrow by a photosensitive drum driving motor not shown with the predetermined process speed and is homogeneously electrified with predetermined polarity and potential by the primary charger 2a (2b, 2c, 2d). The electrified photosensitive drum 1 is exposed by the exposure apparatus 3a (3b, 3c, 3d) based on image information and an electrostatic latent image is formed per each color after removing electric charge of an exposed part.

The electrostatic latent images on these photosensitive drums 1 are developed by the developing apparatuses 100a, 100b, 100c, and 100d (the subscripts will be omitted below because the developing apparatuses of the respective color have the same configuration) as toner images of the respective colors of yellow, magenta, cyan, and black. These four color toner images are primarily transferred sequentially to the intermediate transfer belt 7 by the primary transfer rollers 5a, 5b, 5c, and 5d at the primary transfer nips T1a, T1b, T1c, and T1b. Thus, the four color toner images are superimposed on the intermediate transfer belt 7. Toner left on the photosensitive drum 1 is recovered to each of the developing cases 101a, 101b, 101c, and 101d of the developing apparatus 100.

The four color toner image superimposed on the intermediate transfer belt 7 as described above is secondarily transferred to the recording medium P. The recording medium P conveyed from the cassette 10 by the supplying and conveying apparatus is supplied to the secondary transfer nip portion T2 by matching timing with the toner image on the intermediate transfer belt 7 by the registration roller. The four color toner image on the intermediate transfer belt is collectively and secondarily transferred to the recording medium P supplied as described above by the secondary transfer roller 9 at the secondary transfer nip portion T2.

The recording medium P on which the four color toner image has been secondarily transferred is conveyed to the fixing apparatus 13 and the toner image is fixed to a surface of the recording medium P by heat and pressure applied therein. The recording medium P on which the toner image has been fixed is discharged on the discharge tray not shown. Thus, the process for forming the full-color image on one face (surface) of one recording medium P is completed.

### [Developing Apparatus]

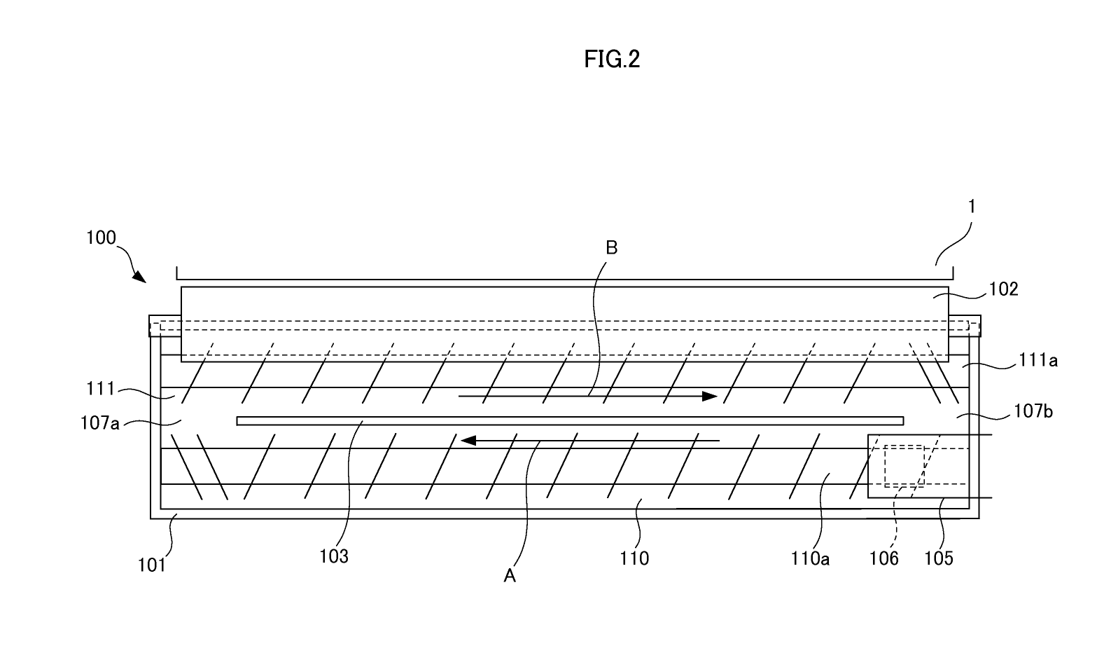

Next, the developing apparatus 100 of the present embodiment will be described with reference to FIGS. 2 through 5. It is noted that because the developing apparatus 100 of the respective colors are constructed in the same manner except of that the colors of the developer stored therein are different, the following description will be made by omitting the subscripts indicating the components of the image forming portions of the respective colors (FIG. 1). FIG. 2 is a section view showing a configuration of the developing apparatus 100 seen from above in FIG. 1. As shown in FIG. 2, the developing apparatus 100 includes a developing case 101. The developing case 101 is provided with a cylindrical developing sleeve 102, i.e., a non-magnetic developer carrier, at an opening located at a position facing in close-proximity to the photosensitive drum 1 of the developing case 101. Each developing apparatus 100 also includes a sealing mechanism 800 configured to seal communication ports 51a and 51b as detailed later.

An inside of the developing case 101 is partitioned such that an agitating chamber 110, i.e., a first chamber, and a developing chamber 111, i.e., a second chamber, are in parallel from each other. That is, the developing chamber 111 and the agitating chamber 110 are partitioned by a partition wall 103. The agitating chamber 110 is provided with a first agitating screw 110a, i.e., a conveying member, fixed rotatably therein (within the first chamber). The developing chamber 111 is also provided with a second agitating screw 111a, i.e., a conveying member, fixed rotatably therein (within the second chamber). The agitating and developing chambers 110 and 111 are configured to be able to store two-component developer containing non-magnetic toner and magnetic carrier, respectively. Then, as the first agitating screw 110a rotates, the two-component developer is conveyed from upstream to downstream of the agitating chamber 110 as indicated by an arrow A. As the second agitating screw 111a rotates, the two-component developer is conveyed from upstream to downstream of the developing chamber 111 as indicated by an arrow B.

The developing apparatus 100 is also provided with communication ports (first and second communication ports) 107a and 107b respectively on upstream and downstream sides, in a developer conveying direction of the first agitating screw 110a, of the partition wall 103. Thereby, the agitating chamber 110 communicates with the developing chamber 111 through the communication ports 107a and 107b, forming a circulation path of the developer. That is, the developer is passed from the agitating chamber 110 to the developing chamber 111 through the communication ports 107a, i.e., the second communication port, and the developer is passed from the developing chamber 111 to the agitating chamber 110 through the communication ports 107b, i.e., the first communication port, respectively.

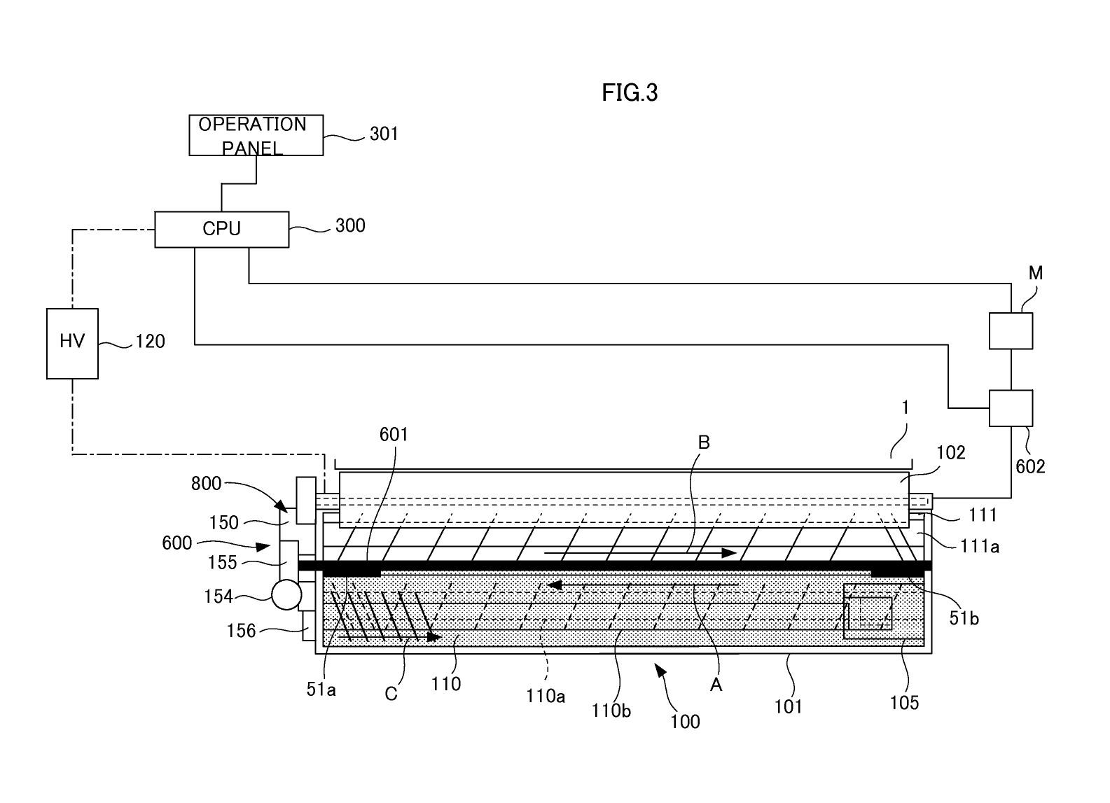

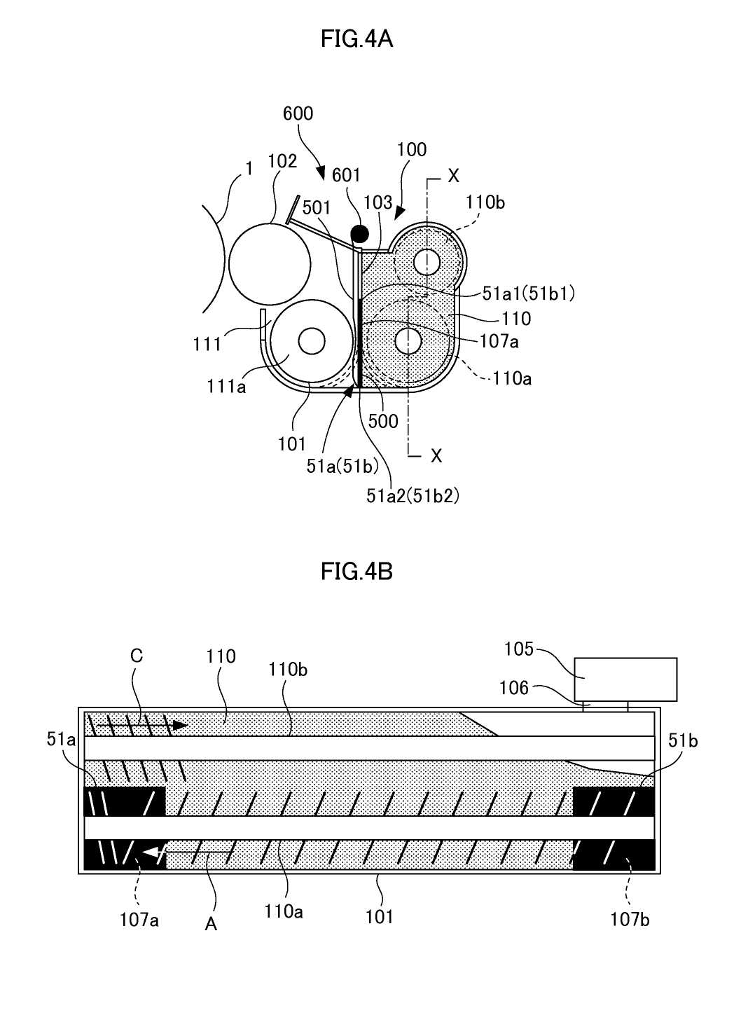

Provided above the upstream side in the developer conveying direction of the agitating chamber 110 is a toner replenishing mechanism 105. Toner stored in a toner bottle not shown is conveyed to the toner replenishing mechanism 105 through a toner conveying path not shown and is dropped and replenished into the agitating chamber 110 through a toner replenishing port 106. It is noted that in the present embodiment, a third agitating screw 110b is disposed above the first agitating screw 110a within the agitating chamber 110 as shown in FIGS. 3, 4A and 4B and as described later. Then, the developer charged into the agitating chamber 110 is circulated within the agitating chamber 110 by being conveyed in a direction (direction C) opposite from the conveying direction (direction A) of the first agitating screw 110a in starting the developing apparatus 100 from the initial state thereof as detailed later.

In the developing apparatus 100 of the present embodiment, a same type of toner and a same type of carrier are used. Here, in the two-component developer using the toner and the carrier, a toner electrification amount is correlated with a rate of toner contained in the two-component developer (referred to as ‘T/D’ hereinafter). Because the toner is electrified by frictionally contacting with the carrier, the greater the opportunity of the contact of the toner with the carrier, the greater the electrification amount is. Accordingly, the smaller the T/D, the greater the toner electrification amount is.

### [Initial State]

Next, the initial state of the developing apparatus 100 will be described with reference to FIGS. 3, 4A and 4B. In the present embodiment, the developing apparatus 100 of each color is removably attached to an apparatus body 201 (see FIG. 1) of the image forming apparatus 200, so that the developing apparatus 100 is replaceable. Therefore, the developing apparatus 100 composes a process cartridge removably attached to the apparatus body 201 together with the photosensitive drum 1, the primary chargers 2a (2b, 2c, 2d) and others for example. It is noted that the process cartridge may be composed only of the developing apparatus 100, beside those other members, and may be removably attached to the apparatus body 201. In any case, as shown in FIGS. 3, 4A and 4B, the developer (shaded part in FIG. 3) is charged into the agitating chamber 110 in a state in which the developing apparatus 100 is new (initial state) like when it has been just replaced.

Still further, in the present embodiment, each developer 100 is provided with a tag 700 (700a 700b, 700c, 700d), i.e., an identification portion, for discriminating the very developing apparatus as shown in FIG. 1. The apparatus body 201 is provided with a sensor 701a (701b, 701c, 701d), i.e., a reading portion, capable of reading the respective tags 700. This arrangement makes it possible to detect that a new developing apparatus 100 whose communication port is sealed is attached to the apparatus body 201 by reading the tag 700 by the sensor 701. That is, the sensor 701 is a detecting portion detecting that the communication ports 107a and 107b are sealed by the sheet members 51a and 51b as described later. Based on this information, the CPU 300 executes an initial starting operation of the developing apparatus also as described later. That is, if the sensor 701 detects that the communication ports 107a and 107b are sealed by the sheet members 51a and 51b, the CPU 300 automatically performs the initial starting operation including an operation for removing the sheet members 51a and 51b as described later. However, this operation may be performed under an instruction of a user.

It is also possible to arrange to provide a write portion configured to write magnetic information or the like to the sensor 701 and to write information that the initial starting operation of the developing apparatus 100 has been completed when the initial starting operation has been actually completed. It is also possible to arrange such that the sensor 701 reads the identification information of the developing apparatus 100 through the tag 700 and to store such information in a storage portion such as a RAM of the apparatus body 201. This arrangement makes it possible to prevent the developing apparatus 100 which has completed the initial starting operation from executing another initial starting operation again in a case when the developing apparatus 100 is taken out by some reason and is attached again.

### [Sheet Member]

Therefore, the communication ports 107a and 107b communicating the agitating chamber 110 with the developing chamber 111 are provided respectively with sheet-like members (seals) 51a and 51b, i.e., sealing members. That is, the sheet member 51a seals the communication ports 107a by being adhered to a circumstance of the communication ports 107a of the partition wall 103 and the sheet member 51b seals the communication ports 107b by being adhered to a circumference of the partition wall 103. Thereby, in the initial state, the developer is charged only into the agitating chamber 110 and no developer including the carrier and toner exists within the developing chamber 111.

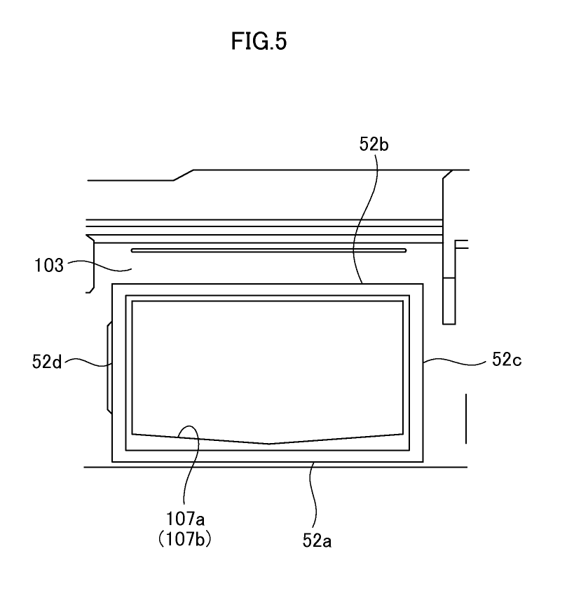

The communication ports 107a and 107b sealed by the sheet members 51a and 51b are opened respectively substantially in a rectangular shape as shown in FIG. 5. While the sheet members 51a and 51b are removed by being peeled off in an upper direction (removing direction) in FIG. 5 as described later, the communication ports 107a and 107b are formed substantially in the rectangular shape having sides substantially in parallel with the removing direction. The sheet members 51a and 51b are also adhered to the peripheral four sides (whole circumference) so as to surround the communication ports 107a and 107b. Specifically, the sheet members 51a and 51b have adhesion portions 52a and 52b, i.e., two parts of both ends in the removing direction and the adhesion portions 52c and 52d, i.e., the two sides extending in a widthwise direction orthogonal to the removing direction, among the circumferences of the communication ports 107a and 107b.

As a result, the sheet members 51a and 51b are adhered to the partition wall 103 such that the part (the adhesion portions 52a and 52b) in the removing direction is wider in area than the other parts (the adhesion portions 52c and 52d). That is, the wide adhesion part includes the adhesion portions 52c and 52d and the area in the width direction orthogonal to the removing direction of the adhesion portions 52a and 52b are wide in terms of the area to be peeled in removing the sheet member in the removing direction. Meanwhile, because the adhesion portions 52c and 52d are formed so as to extend in the removing direction, the widthwise area thereof viewed from an identical level in the removing direction is narrower, even if the both areas of the adhesion portions 52c and 52d are totaled, than either one area of the adhesion portions 52a and 52b. Accordingly, in the present embodiment, the sheet members 51a and 51b are adhered to the partition wall 103 such that the adhesion portions 52a and 52b are wider in area than the adhesion portions 52c and 52d, respectively. It is noted that the adhesion of the sheet members 51a and 51b with the partition wall 103 may be made by melting (welding) the adhesion portion of the sheet members 51a and 51b by heat for example, other than what uses adhesive. In short, any means may be adopted as long as the communication ports 107a and 107b can be tightly sealed by the sheet members 51a and 51b.

### [Configuration for Removing the Sheet Member]

Next, a configuration for removing the sheet members 51a and 51b as described above will be described with reference to FIGS. 3, 4A and 4B, and 6. It is noted that the basic configurations for removing the sheet members 51a and 51b are the same, the following description will be made by typically concerning to the sheet member 51a. As shown in FIG. 4A, the sheet member 51a includes a sealing portion 500 covering the communication ports 107a by being adhered to the partition wall 103 between one end portion 51a1 and an intermediate portion of the sheet member 51a and a folded-back portion 501 folded back from another end portion (the end on the side opposite from the one end portion 51a1 of the sheet member 51a) 51a2 of the sealing portion 500.

Meanwhile, a winding device 600, i.e., the removing device, for removing the sheet member 51a includes a winding shaft 601, i.e., a winding portion. The winding shaft 601 is connected with an end of the folded-back portion 501 of the sheet member 51a on a side opposite from the sealing portion 500. Then, in response to rotation of the winding shaft 601, the sheet member 51a is wound from the folded-back portion 501 and the sealing portion 500 is peeled off from the communication ports 107a. The sheet members 51a and 51b and the winding portion 600 compose a sealing mechanism 800 of the developing apparatus 100 (see FIG. 3).

Here, one winding shaft 601 is disposed to one developing apparatus 100, and the one winding shaft 601 winds the two sheet members 51a and 51b respectively sealing the two communication ports 107a and 107b formed through the partition wall 103. That is, the folded-back portion 501 of the sheet member 51b is also connected to the winding shaft 601. Then, in response to the rotation of the winding shaft 601, the sheet members 51a and 51b are wound by the winding shaft 601 from the folded-back portion 501 and the respective sealing portions 500 are peeled off from the communication ports 107a and 107b. It is noted that a thin sheet-like resin containing polyester of around 0.1 mm thick is used for example as the sheet members 51a and 51b to be wound up by the winding shaft 601 as described above in the present embodiment. It is noted that the materials and shapes of those components used for the sealing mechanism 800 are not limited to those described in the present embodiment.

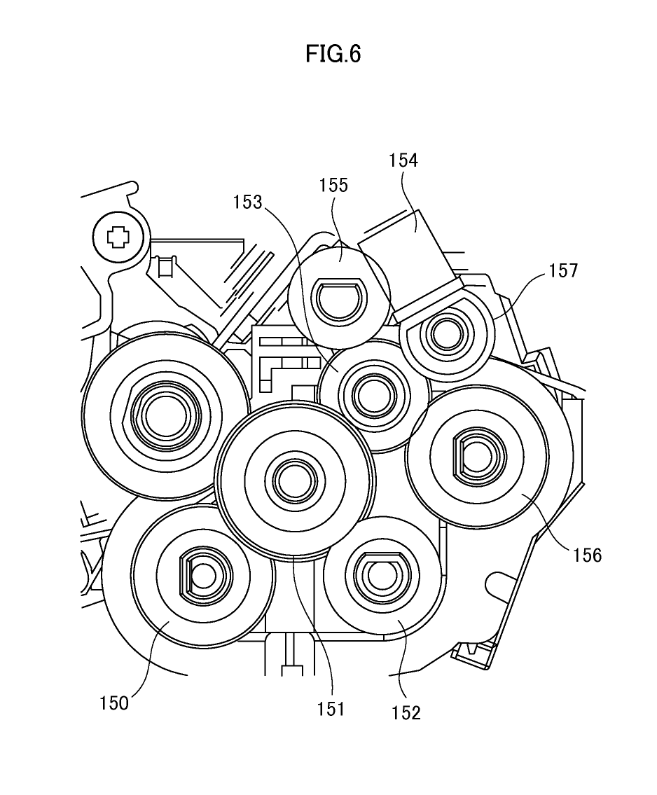

The winding shaft 601 rotating to wind up the sheet members 51a and 51b as described above is driven by the driving motor M, i.e., a driving source driving the developing apparatus 100 as shown in FIG. 3. Here, the developing sleeve 102, the first agitating screw 110a, the second agitating screw 111a, the third agitating screw 110b and the winding shaft 601 composing the developing apparatus 100 are linked by a gear train shown in FIG. 6. The driving motor M is connected to the rotating shaft of the developing sleeve 102 through a clutch 602 as shown in FIG. 3. It is noted that developing bias can be applied to the developing sleeve 102 by a high-voltage power source (HV) 120. The driving motor M, the clutch 602 and the high-voltage power supply 120 are controlled respectively under instructions of the CPU 300, i.e., a control portion. The CPU 300 operates the respective components of the image forming apparatus 200 corresponding to operations made through an operation panel 301 provided as an operation portion in the apparatus body 201.

The image forming apparatus 200 of the present embodiment is configured such that the developing apparatuses 100a, 100b, 100c, and 100d are driven by one driving motor M as shown in FIG. 1. Provided to that end between the driving motor M and the developing apparatuses 100a, 100b, 100c, and 100d are clutches 602a, 602b, 602c, and 602d, i.e., switching devices switching connection/disconnection of transmission of the drive from the driving motor M. That is, these clutches 602a, 602b, 602c, and 602d switch connection/disconnection of the transmission of the driving from the driving motor M by operating under the instruction of the CPU 300 (see FIG. 3). It is noted that because configurations of the respective clutches are the same, the following description will made by omitting the subscripts indicating the components of the image forming portions of particular color unless they are required to be specifically indicated.

As the driving motor M rotates under the instruction of the CPU 300, the clutch 602 is connected and the developing sleeve 102 rotates. Then, the rotation is transmitted to each component through the gear train as shown in FIGS. 3 and 6. That is, the second agitating screw 111a is rotated by the gears 150 and 151, the first agitating screw 110a is rotated by the gears 151 and 152, and the third agitating screw 110b is rotated by the gears 153 and 156, respectively, in linkage. The winding shaft 601 is also turned by the gears 154, 155 and 157 in linkage. That is, the developing apparatus 100 is configured such that the developing sleeve 102, the respective agitating screws 110a, 110b and 110c and the winding shaft 601 are rotationally driven by the driving motor M, i.e., the one and same driving source.

Numbers of rotations of the respective components are as follows: the developing sleeve 102 is set at 250 rpm, the second agitating screw 111a at 300 rpm, the first agitating screw 110a at 400 rpm, and the third agitating screw 110b at 300 rpm, for example. The winding shaft 601 is set at 20 rpm for example. As described above, an agitating force of the first agitating screw 110a is set to be greater than that of the second agitating screw 111a. The winding shaft 601 is arranged to be decelerated by using a warm gear so that torque required for the peeling off operation of the sheet members 51a and 51b can be generated. Still further, the winding shaft 601 is connected with the gear 155 at a position close to the sheet member 51a which is started to be peeled off first as described below among the two sheet members 51a and 51b.

### [Starting Timing for Peeling Off the Sheet Members]

Next, peeling starting timings of the two sheet members 51a and 51b in one developing apparatus 100 will be described. The developer is charged into the agitating chamber 110 and there exists no developer within the developing chamber 111 in the initial state of the developing apparatus 100 as described above. Therefore, in initially starting the developing apparatus 100, the winding shaft 601 described above is rotated to wind up and to remove the sheet members 51a and 51b from the communication ports 107a and 107b. Then, the agitating chamber 110 communicates with the developing chamber 111, so that the developer reaches within the developing chamber 111. That is, a circulation path of the developer is formed by the agitating and developing chamber 110 and 111 during operation.

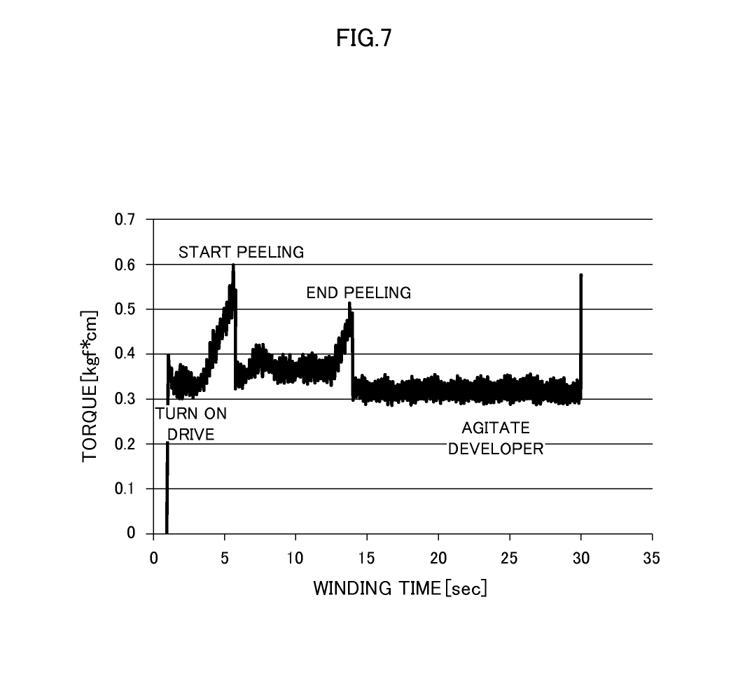

As shown in FIG. 5, the sheet members 51a and 51b are adhered to the partition wall 103 such that the adhesion portions 52a and 52b are wider in area than the adhesion portions 52c and 52d, respectively. Therefore, the adhesion portions 52a whose area is wide is peeled off first in starting a peeling off operation of the sheet members 51a and 51b and the adhesion portions 52b whose area is wide is peeled off in ending the peeling off operation of the sheet members 51a and 51b. Due to that, the torque applied to the driving motor M in peeling one sheet member 51a (or 51b) in initially starting one developing apparatus 100 is represented as shown in FIG. 7. That is, the load increases in peeling off the adhesion portions 52a whose area is wide in starting the peeling off operation and then the load decreases to a level lower than that in starting the peeling off operation because the adhesion portions 52c and 52d whose area is narrow is peeled off linearly. The load increases again because the adhesion portions 52b whose area is wide is peeled off in ending the peeling off operation finally.

Due to that, if the timing of the peeling off operation of at least one of the adhesion portions 52a and 52b which requires the high load overlaps among the two sheet members 51a and 51b, the load applied to the driving motor M considerably increases. Accordingly, in the present embodiment, a length of the fold-back portion 501 of the two (plurality of) sheet members 51a and 51b are differentiated from each other. Then, the adhesion portions 52a and 52b of the two sheet members 51a and 51b which cause the high load are removed (peeled off) at the timings different from each other.

Specifically, the fold-back portion 501 of the sheet member 51a sealing the communication port 107a formed on the downstream side in the developer conveying direction of the first agitating screw 110a is shorter than the fold-back portion 501 of the sheet member 51b sealing the communication port 107b formed on the upstream side in the developer conveying direction. In other words, a length of the sheet member 51b from the other end portion 51b2, i.e., a fold-back point, of the sealing portion 500 to the winding shaft 601 is longer than a length of the sheet member 51a from the other end portion 51a2, i.e., a fold-back point, of the sealing portion 500 to the winding shaft 601. That is, the sheet member 51b, i.e., the first sheet member, is formed such that a winding length between a start of winding by the winding device 600 to a point where a tension acts on the adhesion portion (adhesion face) 52a is longer than the sheet member 51a, i.e., the second sheet member. Therefore, if the winding shaft 601 is rotated, the sealing portion 500 of the sheet member 51a whose fold-back portion 501 is short is started to be peeled off first.

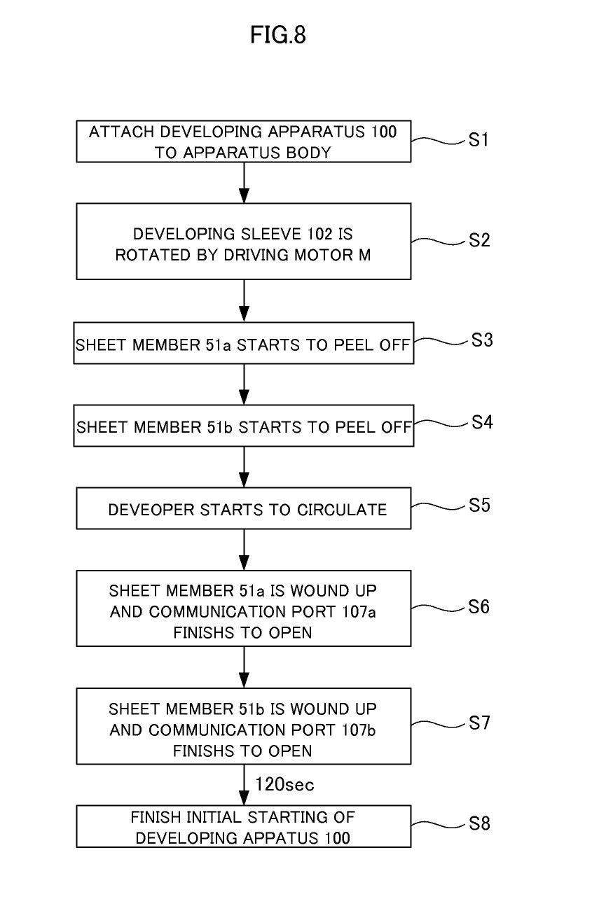

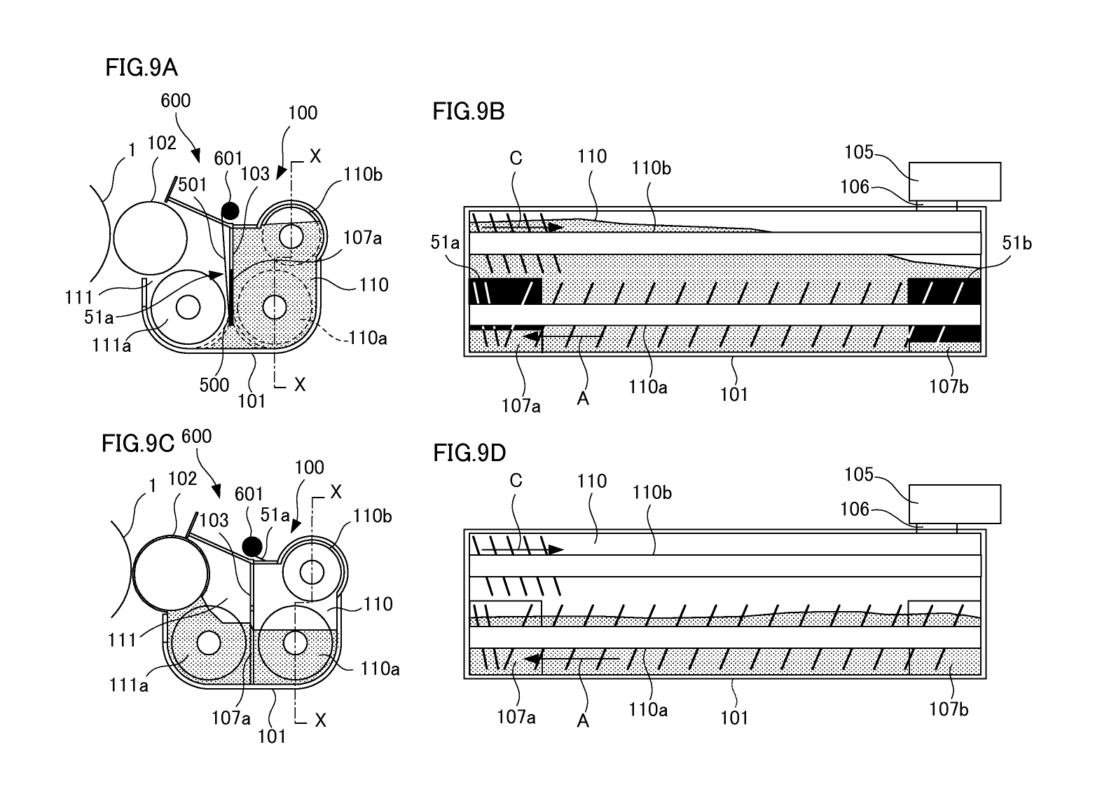

A process in initially starting one developing apparatus as described above will be described along FIG. 8 and with reference to FIGS. 4A and 4B and FIGS. 9A through 9D. At first, the developing apparatus 100 in the initial state is attached (set) first to the apparatus body 201 in Step S1. Next, the driving motor M is rotated under an instruction of the CPU 300 and the developing sleeve 102 rotates in Step S2. In linkage with the rotation of the developing sleeve 102, the first agitating screw 110a, the second agitating screw 111a, the third agitating screw 110b, and the winding shaft 601 rotate.

While the first agitating screw 110a rotates and conveys the developer at this time, the sheet member 51a sealing the communication port 107a downstream in the developer conveying direction is not peeled off yet as shown in FIGS. 4A and 4B. Due to that, the developer gets together downstream in the conveying direction of the first agitating screw 110a. The gathered developer is conveyed by the third agitating screw 110b in the direction of the arrow C. Thereby, the developer circulates within the agitating chamber 110, preventing the first agitating screw 110a from generating excessive torque.

During that time, the winding shaft 601 rotates and the fold-back portions 501 of the sheet members 51a and 51b are wound up. Then, because the sealing portion 500 of the sheet member 51a whose fold-back portion 501 is short is peeled off first, the downstream communication port 107a starts to open in Step S3. At this time, the developer is conveyed gradually from the agitating chamber 110 to the developing chamber 111 through the opened gap. Here, during when the gap is small, the developer circulates by the first agitating screw 110a and the third agitating screw 110b. Then, after a while, the developer is conveyed to the developing chamber 111 by the first agitating screw 110a through the gap from which the sheet member 51a has been peeled off as shown in FIGS. 9A and 9B. The developer conveyed to the developing chamber 111 is conveyed by the second agitating screw 111a.

Next, the sealing portion 500 of the sheet member 51b is also peeled off after the sheet member 51a and the upstream communication port 107b starts to open in Step S4. Then, a certain time elapses since when the sheet member 51b has started to be peeled off by the time when the developer conveyed within the developing chamber 111 by the second agitating screw 111a arrives at the communication port 107b. Therefore, the developer is conveyed to the agitating chamber 110 by the second agitating screw 111a without being blocked by the sheet member 51b and starts to circulate in Step S5.

When the one end portion (downstream end in the removing direction) of the sealing portion 500 of the sheet member 51a is peeled off and ends up being wound up by the winding shaft 601, the communication port 107a is put into a state in which it ends up being opened in Step S6. Then, when the sheet member 51b is wound up by the winding shaft 601, the communication port 107b is put into a state in which it is opened in Step S7. In these states, the developing sleeve 102, the second agitating screw 111a, the first agitating screw 110a and the third agitating screw 110b are rotated for a predetermined period of time, e.g., 120 seconds. Thereby, the two-component developer filled in the developing case 101 is fully agitated and mixed and the initial starting operation of the developing apparatus 100 is finished as shown in FIGS. 9C and 9D in Step S8. At this time, although the winding shaft 601 rotates in linkage, it merely rotates the sheet members 51a and 51b idly, so that the rotation of the winding shaft 601 does not affect the agitation of the developer.

In the present embodiment, the sheet member 51a downstream in the developer conveying direction of the first agitating screw 110a is removed at first as described above to open the downstream communication port 107a first. This arrangement makes it possible for the developer conveyed by the first agitating screw 110a to quickly flow into the developing chamber 111 through the communication port 107a, to suppress the increase of the developer conveying load on the first agitating screw 110a, and to reduce the load applied to the driving motor M. Still further, because the developing sleeve 102 also rotates at this time and the developer flown into the developing chamber 111 is carried and conveyed by the developing sleeve 102, the conveying load of the developer can be reduced further.

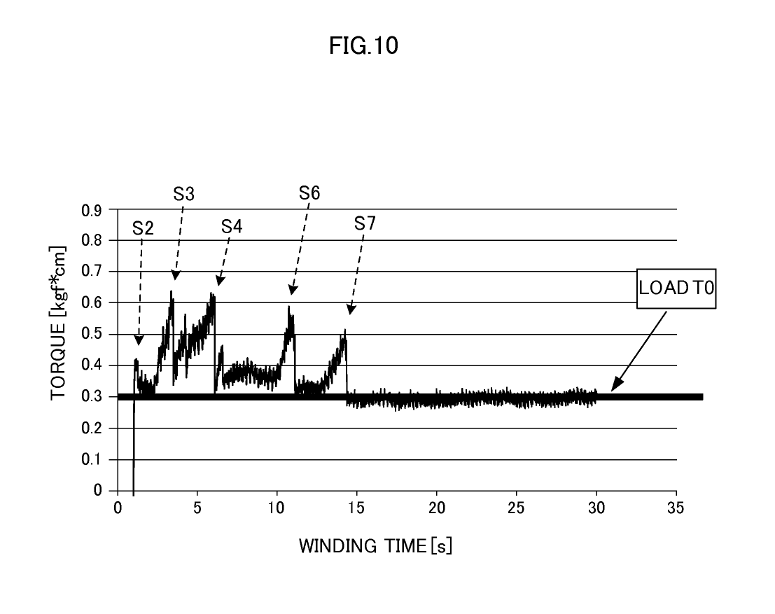

Here, FIG. 10 shows torque applied to the driving motor M at times corresponding to Steps described above in FIG. 8. In the present embodiment, the fold-back portion 501 of the sheet member 51b is formed to be longer than the fold-back portion 501 of the sheet member 51a as described above. Due to that, the timings for peeling off the adhesion portions 52a and 52b which cause the high load in peeling off the sheet members 51a and 51b are different. That is, while the load increases in starting and ending the peeling off operation of the sealing portion 500, respectively, the peeling starting and ending timings of the sealing portion 500 are shifted with respect to the sheet members 51a and 51b. As a result, the load applied to the winding shaft 601 is dispersed and the load applied to the driving motor M is reduced.

More specifically, as shown in FIG. 10, the load increases more or less at a point of time of Step S2 because the developing sleeve 102 and others start to rotate at first as the driving motor M starts to rotate. After that, because the adhesion portions 52a of the sheet member 51a starts to be peeled off in Step S3, the load increases at this point of time (maximum value). Next, because the adhesion portions 52a of the sheet member 51b start to be peeled off in Step S4, the load also increases at this point of time (maximum value). After that, because the adhesion portions 52b of the respective sheet members 51a and 51b start to be peeled off at the different timings in Steps S6 and S7, the load increases at the respective points of time (maximum value).

Thus, because the load for peeling off the sheet members 51a and 51b is applied to the driving motor M in addition to the load required for agitating and conveying the developer, the great load is applied to the driving motor M for a predetermined period of time, e.g., 15 seconds, after initially starting the developing apparatus as compared to a point of time of load T0 (see FIG. 10) required for conveying only the developer. However, in the present embodiment, the timing of the peeling starting and ending times of the sealing portion 500 of the sheet members 51a and 51b during which the high load is caused are shifted. In other words, the maximum values of the load applied in removing the sheet members 51a and 51b are shifted from each other. Accordingly, the maximum load applied to the driving motor M can be suppressed, and the load is suppressed to about twice of the load T0 in maximum in FIG. 10.

### [Initial Starting Operation of a Plurality of Developing Apparatuses]

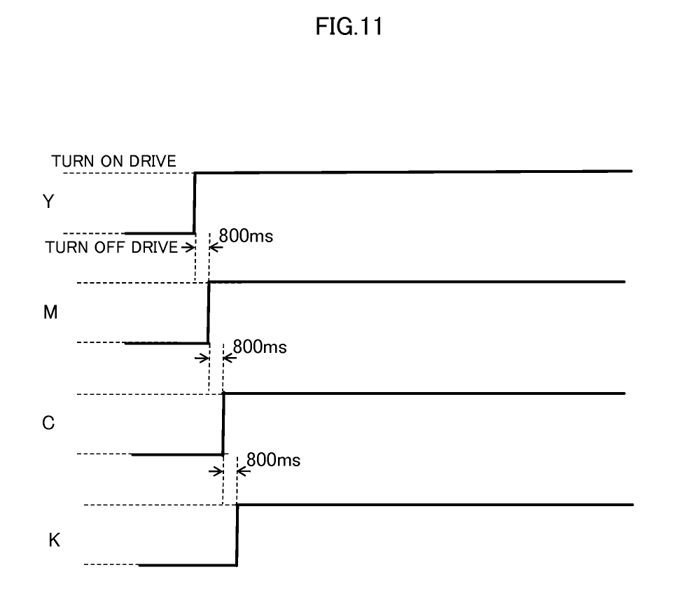

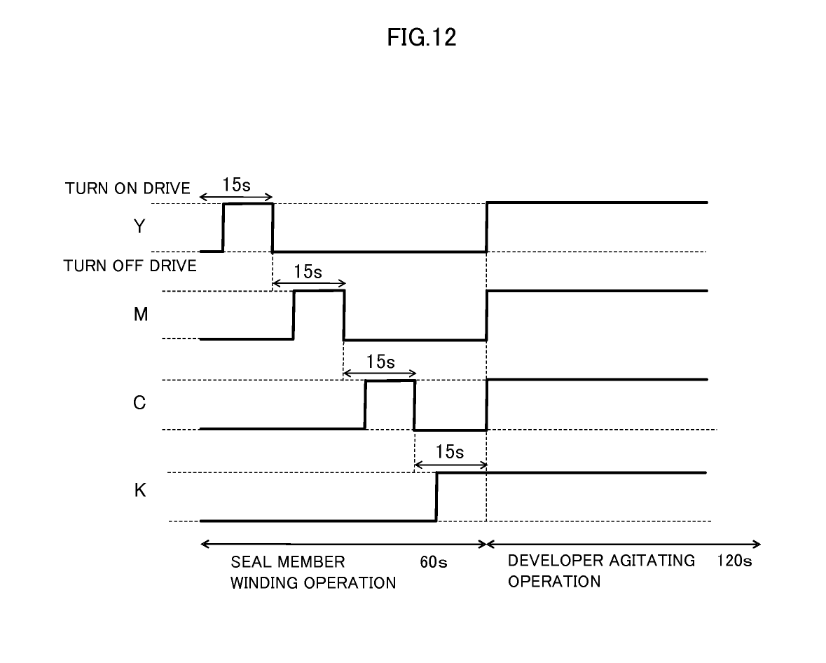

Next, an initial starting operation of the plurality of developing apparatuses 100 will be described with reference to FIGS. 11 and 12. Firstly, a comparative example of the present invention will be described with reference to FIG. 11.

### COMPARATIVE EXAMPLE

FIG. 11 shows timings for starting to drive the developing apparatuses 100a, 100b, 100c, and 100d by turning ON (connecting) the clutches 602a, 602b, 602c, and 602d (see FIG. 1) of the plurality of developing apparatuses in initially starting the developing apparatuses in a comparative example. These timings are identical with timings for connecting the respective clutches in forming an image, i.e., developing drive starting timings. It is noted that ‘turn ON drive’ in FIG. 11 indicates a state in which the driving motor M is started to rotate and the clutch is connected, and ‘turn OFF drive’ indicates a state in which the clutch is disconnected even if the driving motor M is rotated. In the comparative example, the drive is started in order of Y (yellow), M (magenta), C (cyan), and K (black) by shifting by 800 ms, i.e., a time difference, in starting to form an image. At this time, the loads of the four developing apparatuses are applied to the driving motor M, and the load until ending the peeling off operations of all sheet members becomes great. Here, if the load in peeling off the sheet member is 2T0 with respect to the load T0 applied when the developer is merely conveyed, a load of 8T0 is applied to the driving motor M in peeling off the sheet members in addition to a load of 4T0 in conveying the developer in the comparative example in which the four developing apparatuses are driven. Therefore, a costly driving motor M is required in the comparative example to be able to sustain the great load in initially starting the developing apparatuses.

### [Initial Starting Operation of the Present Embodiment]

Next, the initial starting operation of the plurality of developing apparatuses 100a, 100b, 100c, and 100d of the present embodiment (subscripts will be omitted below because the developing apparatuses of the respective colors have the same configuration) will be described with reference to FIG. 12. In the present embodiment, the CPU 300 (see FIG. 3) controls the clutches 602a, 602b, 602c, and 602d such that the adhesion portions 52a and 52b of the plurality of sheet members 51a and 51b are removed at timings different from each other among the plurality of developing apparatuses 100. Specifically, the CPU 300 controls such that the adhesion portions 52a and 52b of the sealing portion 500 which cause the high load are peeled off at the different timings by differentiating removal starting timings of the plurality of sheet members 51a and 51b among the plurality of developing apparatuses 100. It is noted that the clutches have the same configuration for the respective colors, so that the subscripts will be omitted below unless required specifically. Still further, ‘turn ON drive’ in FIG. 12 indicates a state in which the clutch 602 is connected in a state in which the driving motor M is rotated, and ‘turn OFF drive’ indicates a state in which the clutch 602 is disconnected even if the driving motor M is rotated.

This operation will be described specifically below. The present embodiment is arranged such the operations for winding the sheet members 51a and 51b which causes the great load are not conducted simultaneously among the plurality of developing apparatuses 100. As shown in FIG. 10 and described above, a time required to wind up the sheet members 51a and 51b in one developing apparatus 100 is about 15 seconds (predetermined time). That is, the time from the start of the drive of the driving motor M and the connection of the clutch 602 until when the winding of the sheet members 51a and 51b is completed in the configuration in which the length of the fold-back portion 501 of the sheet members 51a and 51b is differentiated is supposed to be the predetermined time. The predetermined time is about 15 seconds in the present embodiment. Accordingly, in the present embodiment, the drive is started, i.e., the clutch 602 is turned ON, in the order of Y (yellow), M (magenta), C (cyan), and K (black) by shifting the start of the winding operation by each predetermined time (15 seconds each). Therefore, because the respective developing apparatuses 100 perform the operation for winding up the sheet members 51a and 51b by 15 seconds one by one, the sheet members of all of the developing apparatuses 100 are peeled off in 60 seconds in total. Still further, in the present embodiment, the clutches 602, except of the clutch 602 of the final black developing apparatus 100, are turned OFF (disconnected) at a point of time after an elapse of 15 seconds from the completion of the operation for winding up the sheet members 51a and 51b, i.e., from turn ON (connection) of each clutch 602.

In the case of the present embodiment as described above, the adhesion portions 52a and 52b of the sheet members 51a and 51b which are adhered to the partition wall 103 with the wider area than the other part and which cause the great load when they are to be removed are removed at the timing different from each other among the plurality of developing apparatuses 100. That is, as shown in FIG. 10, the peeling starting and ending timings of the sheet members 51a and 51b which cause the high load are shifted in one developing apparatus 100. In addition to that, periods for the peeling off operation of the sheet members 51a and 51b are shifted among the plurality of developing apparatuses 100. Accordingly, it is possible to reduce the load applied to the driving motor M in removing the sheet members 51a and 51b from the communication ports 107a and 107b.

As shown in FIG. 10 and descried above, the maximum load applied to the driving motor M including the load required for peeling off the sheet members 51a and 51b is subsutansially 2×T0 in one developing apparatus 100. Still further, the period for peeling off the sheet members 51a and 51b is shifted in each developing apparatus 100. Accordingly, in the present embodiment, the maximum load applied to the driving motor M is 2T0 even if the sheet members 51a and 51b of all of the developing apparatuses 100 are removed by driving one driving motor M. That is, the maximum load applied to the driving motor M while performing the peeling off operation of the sheet members 51a and 51b of the respective developing apparatuses 100 is 2T0 required to peel off the sheet members 51a and 51b of one developing apparatus 100.

Meanwhile, the clutch 602 of Y, M, C are connected again while connecting the clutch 602 of K in a state in which the operation for peeling off the sheet members 51a and 51b of all the developing apparatuses 100 is finished and the load of the driving motor M is stabilized and becomes small. At this time, the developing sleeve 102, the second agitating screw 111a, the first agitating screw 110a, and the third agitating screw 110b of all of the developing apparatuses 100 are rotated for 120 seconds. Thereby, the two-component developer is fully agitated and mixed within the developing case 101 of the respective developing apparatuses 100, and the initial starting operation of the respective developing apparatuses 100 is finished. During this period of time, the maximum load applied to the driving motor M is 4×T0 required to convey the developer in the four developing apparatuses 100. Thus, according to the present embodiment, the maximum load applied to the driving motor M can be reduced from 8×T0 to 4×T0 as compared to the comparative example. As a result, a more costly motor can be used as the driving motor M.

### Second Embodiment

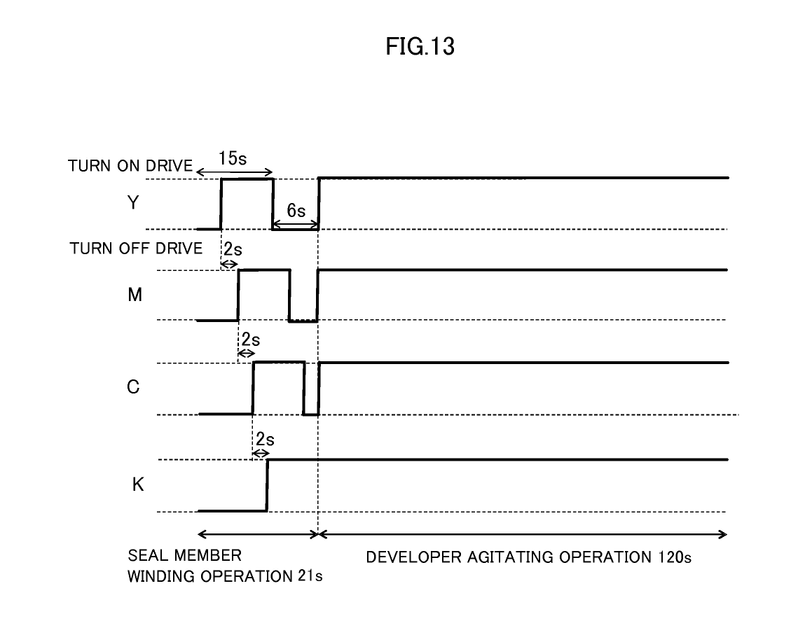

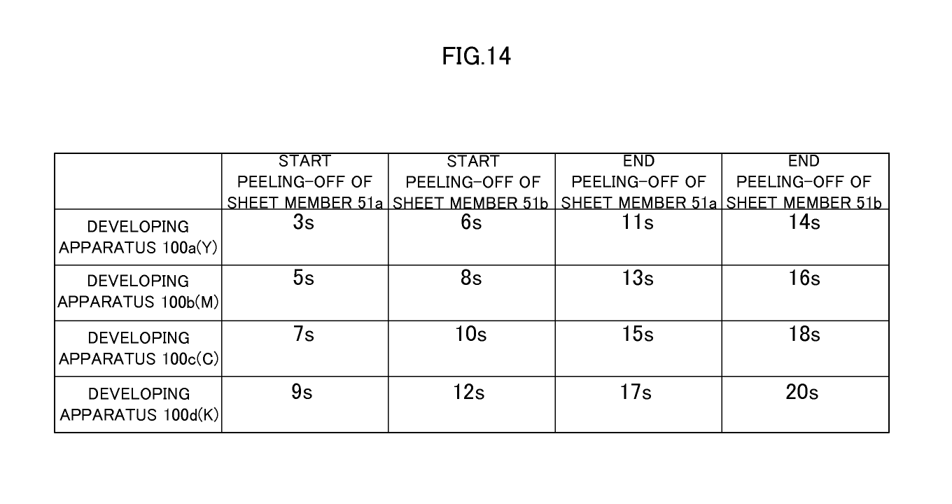

A second embodiment of the present invention will be described with reference to FIGS. 13 and 14. The period (15 sec.) for peeling off the sheet members 51a and 51b of each developing apparatus 100 and the timing for connecting the clutch 602 have been shifted in initially starting the plurality of developing apparatuses 100 in the first embodiment described above. However, 15 seconds required for the starting operation in each developing apparatus is prolonged to 60 seconds in the four developing apparatuses and the initial starting operation is prolonged by 45 seconds. To that end, the timing for connecting the clutch 602 is arranged such that the initial starting operation of the present embodiment is shorter than that of the first embodiment. The other configuration and operations are the same with those of the first embodiment, overlapped illustrations and descriptions will be omitted or simplified here, and the following description will be made centering on features of the present embodiment.

As shown in FIG. 10 and described above, the load increases in particular in starting and ending the peeling off operation of the sheet members 51a and 51b in initially starting the developing apparatus. Times when the load increases in particular after starting to drive the developing apparatus are 3 seconds (Step S3), 6 seconds (Step S4), 11 seconds (Step S6) and 14 seconds (Step S7). Accordingly, in the present embodiment, drive starting timings of the developing apparatus 100a is delayed by 2 seconds each such that the timings when the load is increased in particular by the peeling off operation of the sheet members 51a and 51b are not synchronized among the plurality of developing apparatuses as shown in FIG. 13. That is, ON timing of the clutch 602 is shifted by 2 seconds each in the order of Y, M, C, and K.

FIG. 14 is a table showing respective peeling starting and ending times of the sheet members 51a and 51b in the respective developing apparatuses 100 after starting the initial starting operation in the case where the ON timings of the clutch 602 are shifted as described above. As it is apparent from FIG. 14, the peeling starting and ending times of the sheet members 51a and 51b which cause the high load are shifted in each developing apparatus 100. Accordingly, it is possible to reduce the load applied to the driving motor M also by the present embodiment. Still further, in the case of the present embodiment, a time required for winding up the sheet members 51a and 51b of all of the developing apparatuses 100 is 21 seconds as shown in FIG. 13. That is, an increase of time is only 6 seconds as compared to the case of one developing apparatus. Accordingly, it is possible to shorten the time of the initial starting operation considerably by peeling off the sheet members 51a and 51b as described above. It is noted that the time by which the drive starting timing of each developing apparatus 100 is shifted is not limited to the value described above and depends on the configuration of the developing apparatus 100.

### Other Embodiment

It is noted that the configuration in which the sheet member is adhered to the circumference of the substantially rectangular communication port and in which the load increases at the peeling starting and ending timings has been described in each embodiment described above. However, the load required in peeling off the sheet members is affected not only by the adhesion area but also by an amount of adhesive. That is, the load is reduced if the amount of the adhesive is less, and the load increases if the amount of the adhesive is more. Still further, the position where the sheet member is adhered or the shape of the adhesion portion vary depending on the shape of the communication port, and the load does not always increase at the peeling starting and ending timings. Accordingly, sheet member peeling timings are shifted or the lengths of the fold-back portion 501 are differentiated such that the timings (of maximum value) causing the high load are shifted corresponding to the amount of the adhesive, the position to be adhered, the shape of the adhesion portion, and others.

Still further, the connection timing of the clutch 602 is shifted among the respective developing apparatuses 100 in the explanation described above, it is possible to configure such that the timing causing the high load is shifted by only differentiating the length of the fold-back portion 501. That is, the peeling starting timing can be shifted even if the operation for winding up the sheet members 51a and 51b are started simultaneously by differentiating the length of the fold-back portion 501 of the sheet members 51a and 51b of all of the developing apparatuses 100. This arrangement makes it possible to eliminate the clutch 602.

Still further, it is not necessary to shift all of the timings causing the high load in peeling off the sheet members 51a and 51b of all of the developing apparatuses 100, and some may overlap. It is possible to reduce the load also in this case as compared to the case when the timings causing the high load overlap in all of the developing apparatuses 100. For instance, the timing causing the high load in peeling at least either one of the sheet members is shifted by differentiating the length of the fold-back portion 501 of at least either one of the plurality of sheet members 51a and 51b from the other sheet member 51a or 51b.

Still further, all of the developing apparatuses 100 are driven by the driving motor M in the explanation described above. However, the present invention is applicable also to any configuration as long as a plurality of developing apparatuses, not all of the developing apparatuses necessarily, is driven by one driving motor. For instance, in a case where the developing apparatuses of Y, M and C are driven by one motor and the developing apparatus of K is driven by another motor, the present invention can be applied to the configuration in which the developing apparatuses of Y, M and C are driven. Still further, the present invention is applicable not only to the case of initially starting all of the developing apparatuses, but also to a case of initial starting a plurality of developing apparatuses is carried out simultaneously due to replacement and others.

The sheet member is adhered to the circumference of the communication port as a sealing member sealing the communication port in the explanation described above. However, the sealing member is not limited to have such configuration and may be configured such that an elastic member such as rubber is fitted closely to the communication port by its elastic force. If a high load is caused at timing for removing the elastic member from the communication port, such timing may be shifted.

Still further, the removing device removing the sealing member may be configured not only by those including the winding device as described above, but also by a device removing the sheet member or the elastic member from the communication port by sliding or pulling the sheet member or the elastic member.

Still further, while the agitating chamber 110, i.e., the first chamber, has the two communication ports 107a and 107b communicating with the developing chamber 111, i.e., the second chamber, the agitating chamber 110 may be configured to have at least one communication port communicating inside and outside of the chamber. That is, beside the two communication ports described above, the agitating chamber 110 may have another communication port sealed by the sealing member (sheet member). Then, timing for removing the sealing member is shifted from that of other sealing members also in this case. It is also possible to arrange such that the timing for removing the sealing member is not changed between the sealing members within one developing apparatus and the removal timing is only shifted among the sealing members of different developing apparatuses.

Embodiments of the present invention can also be realized by a computer of a system or apparatus that reads out and executes computer executable instructions recorded on a storage medium (e.g., non-transitory computer-readable storage medium) to perform the functions of one or more of the above-described embodiment(s) of the present invention, and by a method performed by the computer of the system or apparatus by, for example, reading out and executing the computer executable instructions from the storage medium to perform the functions of one or more of the above-described embodiment(s). The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2014-038531, filed on Feb. 28, 2014, which is hereby incorporated by reference herein in its entirety.

What is claimed is:

1. An image forming apparatus comprising:
a plurality of developing apparatuses, each of the developing apparatuses including:
a first chamber storing developer in an initial state and having at least one communication port communicating an inside and an outside of the first chamber;
a second chamber forming a circulation path of the developer with the first chamber during operation;
at least one sealing member sealing the communication port by being adhered to a circumference of the communication port in the initial state, the sealing member including a wide adhesion part which is adhered to be wider in area in a width direction orthogonal to a removing direction to be removed than another part in the removing direction; and
a removing device configured to remove the sealing member from the communication port;
a driving source driving each removing device of the plurality of developing apparatuses;
a plurality of switching devices switching connection/disconnection of transmission of a drive of the driving source and each removing device; and
a control portion controlling the plurality of switching devices such that the wide adhesion part of each sealing member is removed at timings different from each other per each developing apparatus.

2. The image forming apparatus according to claim 1, wherein the control portion differentiates timings for starting to remove the plurality of sealing members per each developing apparatus.

3. The image forming apparatus according to claim 1, wherein the sealing member is a sheet member having a sealing portion adhered to the circumference of the communication port between one end portion and an intermediate portion of the sheet member and covering the communication port, and a fold-back portion folded back from an end portion of the sealing portion on a side opposite from the one end portion of the sheet member,
wherein the removing device includes a winding portion configured to wind up the sheet member from an end of the fold-back portion on a side opposite to the sealing portion, and
wherein a length of the fold-back portion of at least either one of the plurality of sheet members is different from that of the other sheet members.

4. The image forming apparatus according to claim 3, wherein each developing apparatus includes:
a conveying member driven by the driving source and conveying the developer within the first chamber; and
a partition wall partitioning the first and second chambers and provided the communication ports communicating the first chamber with the second chamber, the communication ports formed upstream and downstream sides of the partition wall in a developer conveying direction of the conveying member,
wherein the one winding portion is disposed in one developing apparatus and the one winding portion winds the two sheet members respectively sealing the two communication ports formed through the partition wall, and
wherein the fold-back portion of the sheet member on the downstream side in the developer conveying direction of the conveying member of the first chamber among the two sheet members is shorter than the fold-back portion of the sheet member on the upstream side in the developer conveying direction.

5. The image forming apparatus according to claim 1, wherein the developing apparatus includes a developer carrier driven by the driving source and carrying and conveying the developer in the second chamber.

6. The image forming apparatus according to claim 1, wherein the communication port is opened substantially in a rectangular shape having sides substantially in parallel with the removing direction,
the sealing member is adhered to a whole circumstance of the communication port, and
the wide adhesion part of the sealing member includes two potions on the both end in the removing direction among the circumference of the communication port.

7. The image forming apparatus according to claim 1, further comprising a detecting portion detecting that the communication port of the developing apparatus is sealed by the sealing member,
wherein the control portion automatically performs an operation for removing the sealing member in a case when the detecting portion detects that the communication port is sealed by the sealing member.

8. An image forming apparatus comprising:
a plurality of developing apparatuses, each of the developing apparatuses including:
a first chamber storing developer in an initial state and having at least one communication port communicating an inside and an outside of the first chamber;
a second chamber forming a circulation path of the developer with the first chamber during operation;
at least one sheet member sealing the communication port by being adhered to a circumference of the communication port in the initial state, the sealing member including a wide adhesion part which is adhered to be wider in area in a width direction orthogonal to a removing direction to be removed than another part in the removing direction; and
a winding device configured to remove the sheet member from the communication port by winding up the sheet member; and
a driving source driving each winding device of the plurality of developing apparatuses,
wherein the wide adhesion parts of the sheet members of the plurality of developing apparatus are removed at different timings from each other per each developing apparatuses.

9. The image forming apparatus according to claim 8, wherein each developing apparatus includes:
a conveying member driven by the driving source and conveying the developer within the first chamber; and
a partition wall partitioning the first and second chambers and provided the communication ports communicating the first chamber with the second chamber, the communication ports formed upstream and downstream sides, in a developer conveying direction of the conveying member, of the partition wall,
wherein the one winding portion is disposed in one developing apparatus and the one winding portion winds the two sheet members respectively sealing the two communication ports formed through the partition wall, and
wherein the fold-back portion of the sheet member on the downstream side in the developer conveying direction of the conveying member of the first chamber among the two sheet members is shorter than the fold-back portion of the sheet member on the upstream side in the developer conveying direction.

10. An image forming apparatus comprising:
a plurality of developing apparatuses, each of the developing apparatuses including:
a first chamber storing developer in an initial state and having at least one communication port communicating an inside and an outside of the chamber;
a second chamber forming a circulation path of the developer with the first chamber during operation;
at least one sealing member sealing the communication port in the initial state; and
a removing device configured to remove the sealing member from the communication port; and
a driving source driving each removing device of the plurality of developing apparatuses,
wherein the removing devices remove the sealing members such that a maximum value of a load in removing of each sealing member of the plurality of developing apparatuses is shifted from each other.
